(19) United States
(12) Patent Application Publication
(10) Pub. No.: US 2008/0249994 A1
(43) Pub. Date: Oct. 9, 2008

(54) System and process for server side stateless data interchange

(75) Inventor: Eric Passmore, Ashburn, VA (US)

Correspondence Address: DERGOSITS & NOAH LLP, FOUR EMBARCADERO CENTER, SUITE 1450, SAN FRANCISCO, CA, 94111, US

(73) Assignee: Calder Group, Inc., Ashburn, VA (US)

(21) Appl. No.: 11/903,551

(22) Filed: Sep. 21, 2007

Related U.S. Application Data
(60) Provisional application No. 60/861,665, filed on Nov. 28, 2006.

(51) Int. Cl. G06F 17/30; G06F 15/16

(52) U.S. Cl. 707/3; 709/232; 707/E17.014

(57) ABSTRACT

A system and process for data exchange using a stateless router and stateless server is disclosed. Using commodity hardware, the present invention enables assembly of a flexible extensible information management system without complexity or productivity loss. Comprising of a client computer, a stateless router, a stateless server and a database stored in a persistent layer associated with the stateless server, the present invention is easy to set up and use. System elements may communicate over a network, and consistency between data records is defined by an item-schema. The server accepts data record requests from the client, and automatically locates the requested data record. Because it is stateless, it retains no record of the data record transaction, and does not need to anticipate future requests.

### RELATED APPLICATION DATA

This nonprovisional utility patent application claims priority under 35 U.S.C. § 119(e)(1) to provisional patent application No. 60/861,665, filed on Nov. 28, 2006.

### TECHNICAL FIELD

The present invention relates generally to data management, and specifically, to the use of a stateless server and router coupled to a persistent layer database for efficient inventory and resource tracking.

### BACKGROUND OF THE INVENTION

The efficient exchange and management of data is integral to any modern organization. New challenges have emerged as the amount and variety of data have rapidly increased. These increases are driven by advancements in technology, increased competition among organizations, and the emergence of a rapidly expanding marketplace for consumer electronics and personal digital assistants. Over the last decade and a half, worldwide internet bandwidth capacity has increased rapidly while prices for bandwidth have steadily fallen. Storage capacity has followed the same trend with greater amounts of storage available for progressively lower prices. These two technological advancements have made it easier for organizations large and small to produce, record and analyze more data than ever before. With the drop in prices, new systems are emerging to digitize and analyze data once considered too esoteric or too costly to process. This has provided a huge opportunity for organizations to increase productivity by recording, measuring, and analyzing all aspects of their operations. Additionally, the amount of data available for access, management and upkeep has increased dramatically.

Similarly, the portable consumer electronics industry has grown significantly. In the same decade and a half, there has been an explosion in the number of portable consumer electronics being carried by people, from cell phones, to personal media players, to digital cameras. Many such devices are internet and network-enabled, permitting access to vast amounts of data. As these trends converge, consumers, organizations, and employees demand faster, near real-time access to this data.

Unfortunately, the underlying technology behind these advances was founded on previously scarce bandwidth and limited storage capability. These legacy systems performed well in the past, but have become increasing expensive, complex, and slow. What is needed is new technology able to meet the needs of the changing landscape and deliver information to people in real time. What is needed is a cheaper, simpler, and high-performance solution that may scale to make use of the vast amounts of storage and bandwidth that are now readily available. What is needed is a system that is easy to set up, easy to implement and easy to adopt, without compromising data integrity, without increasing the propensity for data collision and corruption, and without restricting users to currently outdated information management solutions.

### SUMMARY OF THE INVENTION

The current invention is directed toward a system and process for efficiently updating, managing and accessing data records via a stateless router and server. In one embodiment, the system includes a client, a router, a server, a database and a network connection between the client, the router, and the server. The router may exist as part of the server or as an independent entity. The database may exist on the server or on a separate persistence layer. In one embodiment of the present invention, the router and server are stateless and keep no record of previous transactions. As such, the router and server may not need any information outside of the single query or request that they are processing. This may simplify router and server design because neither the router nor the server needs to allocate storage to deal with transactions in progress, or worry about balancing memory resources if the client computer times out or encounters an error. In one embodiment, communication between the client, server and persistence layer is kept consistent by adoption of a common schema, or item-schema. Communication may be similarly stateless.

In using an embodiment of the present invention, the client computer generates data record requests or updates from the user. The user may either enter in commands using the item-schema format, or in another embodiment, the client computer may package requests to conform to the item-schema. In one embodiment, the request is sent over the network to the router, which parses the request to draw out the necessary information needed to locate the data record. After applying an algorithm, in one embodiment, the router sends the request to the appropriate server which in turn connects with the persistence layer where the data record is stored. Depending on the nature of the request, the data record may either be returned, or the data record may be updated and a response describing success or failure may be returned.

An embodiment of the present invention provides users with a system and process that is quick to assemble and easy to implement. Because individual system elements are readily available on the market, the present invention may obviate issues regarding database scalability and data migration. The stateless nature of the router, server and communication within an embodiment of the present invention may lessen the chance for data collision and data corruption by a component intermediary.

### BRIEF DESCRIPTION OF THE FIGURES

The present invention is illustrated by way of example and not limitation in the Figures of the accompanying drawings, in which like references indicate similar elements, and in which:

FIG. 1 illustrates a general apparatus for the claimed system where the stateless router and the stateless server are separate entities, according to one embodiment of the present invention.

FIG. 2 illustrates a general apparatus for the claimed system where the stateless router and stateless server are hosted on a single entity.

FIG. 3 illustrates a symbolic overview of the present invention in action, according to one embodiment of the present invention.

FIG. 4 illustrates a symbolic overview of multiple clients accessing a single stateless server with a single persistence layer, according to one embodiment of the present invention.

FIG. 5 illustrates a symbolic overview of multiple clients accessing multiple stateless servers with multiple persistence layers, according to one embodiment of the present invention.

FIG. 6 illustrates a symbolic overview of multiple clients accessing multiple stateless servers with multiple persistences layers through multiple routers.

### DETAILED DESCRIPTION OF THE INVENTION

A data interchange system coupled to a stateless router and server are disclosed. In the following description, for purposes of explanation, numerous specific details are set forth in order to provide a thorough understanding of the present invention. It will be evident, however, to one of ordinary skill in the art, that the present invention may be practiced without these specific details. In other instances, well-known structures and devices are shown in block diagram form to facilitate explanation. The description of the preferred embodiments is not intended to limit the scope of the claims appended hereto.

Aspects of the present invention may be implemented on one or more computers executing software instructions. According to one embodiment of the present invention, router, server and client computer systems transmit and receive data over a computer network and/or a wireless, fiber or copper-based telecommunications network. The steps of accessing, downloading, and manipulating the data, as well as other aspects of the present invention are implemented by central processing units (CPU) in the server and client computers executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the router, server or client computers from a storage device or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the CPU may directly support the downloaded instructions. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, or to any particular source for the instructions executed by the router, server or client computers. In some instances, the client and router and/or server functionality may be implemented on a single computer platform.

Aspects of the present invention can be used in a distributed electronic commerce application that includes a client/router/server network system that links one or more router/server computers to one or more client computers, as well as router/server computers to other router/server computers and client computers to other client computers. The client and router/server computers may be implemented as desktop personal computers, workstation computers, mobile computers, portable computing devices, personal digital assistant (PDA) devices, cellular telephones, digital audio or video playback devices, or any other similar type of computing device. For purposes of the following description, the terms “network,” “computer network,” and “online” may be used interchangeably and do not imply a particular network embodiment or topography. In general, any type of network (e.g., LAN, WAN, or Internet) may be used to implement the online or computer networked implementation of the present invention. Similarly, any type of protocol (e.g., HTTP, FTP, ICMP, UDP, WAP) may be used to communicate across the network.

Aspects of the present invention involve use of a stateless router and server coupled to a data store on a persistent memory layer. One skilled in the relevant art will appreciate that a stateless router/server treats each data request as an independent transaction unrelated to any previous request. A well-known example of a stateless router/server is the World Wide Web router/server, which takes requests (URLs) that completely specify a desired document, but does not require any context or memory of previous requests. (See, e.g., http://en.wikipedia.org/wiki/Stateless_server). The use of a stateless router/server associated with a database is not a new concept, but its application in the present invention is unique.

The present invention involves accessing, updating and querying of data stored in a persistent memory store. While the term data and data records are used interchangeably, the use of these terms is not intended to be limiting in any way. Requests for information through the stateless server involve accessing, updating and querying of information organized by pre-defined domains, and the data records stored therein can also by described as domain members or record set members. One skilled in the relevant art will appreciate that the diversity of the information that can be stored is not limited by use of the terms data or data records.

### System Elements

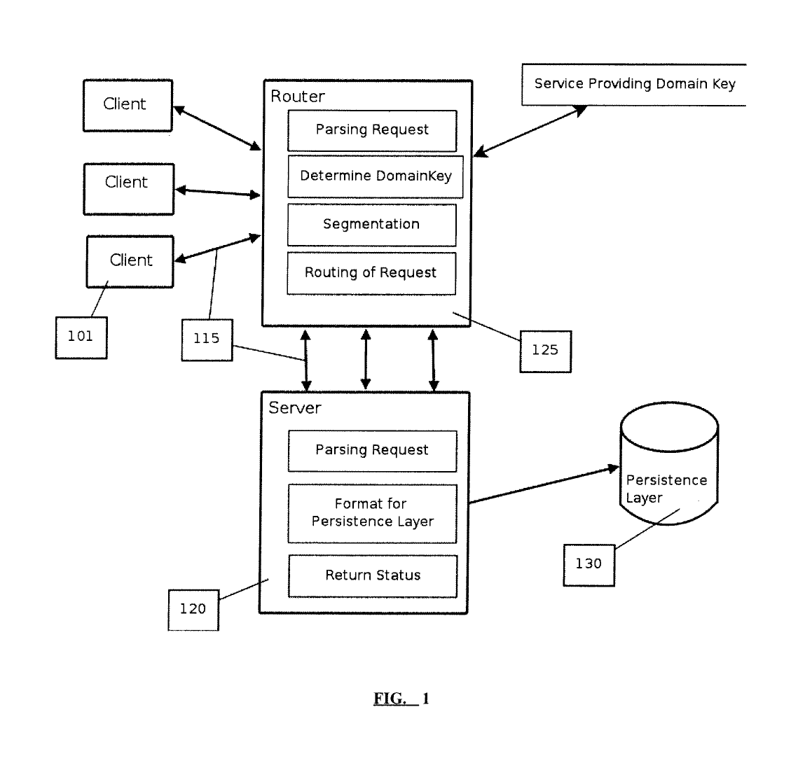

Referring now to FIG. 1, the preferred embodiment of the present invention comprises at least the following elements: one or more client computers 101, a stateless router 125, a stateless server 120, a network or communication layer 115 connecting the client computers 101 to the router 125 and the server 120, and a database stored in a persistence layer 130 associated with the server 120. Communication over the network 115 can be accomplished with a number of protocols, so long as the client, router, and stateless server can both understand the established protocol. In a preferred embodiment, the communication layer of the present invention uses HyperText Transfer Protocol (HTTP); however, FTP, UDP and other well-known protocols in the art are also permissible.

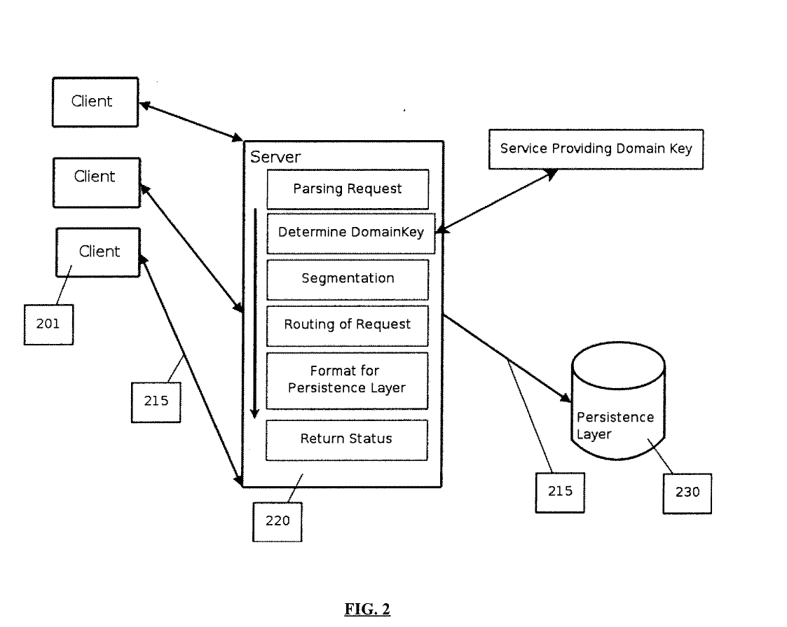

In another embodiment, the router and server can be hosted in a single device. In FIG. 2, one or more client computers 201 are connected via a communication layer 215 to the stateless server 220, which is in turn connected via the communication layer 215 to a persistence layer 230 associated with stateless server 220.

Individually, the elements of the preferred embodiment cannot practice the present invention without adoption of a common schema or “item-schema.” The item-schema defines the structure, content and, to some extent, the semantics of the requests and updates between each system element. The item-schema also standardizes the data record query and update methods. In the present invention, a query is a request for information about the database, and may also be used to request information about records in the system and attributes of those records. The update method changes information in the database, items in the database and attributes of those items. In the preferred embodiment, the item-schema also sets the available data record attributes in extensible markup language (XML); alternatively, other data record formats can also be used. Having a client, router and server apply the same item-schema ensures efficient and meaningful exchange of the data.

The client computer 101, stateless router 125, and stateless server 120 of FIG. 1 can be any computing device commonly known in the art. One skilled in the relevant art will appreciate that the router and/or server can be a hardware component of the invention, or can refer wholly or partially to a software component that manages the database. The present invention can be contained on a single router/server, with both elements contained on a single logical or physical entity, or distributed across multiple router/servers connected by the network. As the system is stateless, no parity or affinity is required between the clients, the router or the server. Each can be combined in a variety of different numbers and configurations. In one embodiment, a web-enabled application server can act as a container for multiple other applications, to which router/server functionality is added. The router/server can be dedicated to host the present invention, or can be used simultaneously for other computing purposes, as long as it maintains statelessness. According to one embodiment of the present invention, the role of the stateless server is to: (1) parse the requests to determine the type of request made and locate the record requested; (2) route the request to the correct destination (when more than one server or persistence layer is involved); (3) translate the request into a format that the persistence layer will understand; (4) update or retrieve the data from the persistence layer; and (5) send back a status code indicating whether the request was a success or failure. In the preferred embodiment, the server is divided into two modules. As shown in FIG. 1, the router 125 (1) parses the request and (2) sends the request to the correct server 120, while the server 120 (1) parses the request again, (3) translates the request, (4) updates or retrieves the data from the persistence layer 130, and (5) sends back a status code.

In the preferred embodiment, communication between the client, server, and router is stateless; meaning neither the server nor the router keeps records of past transactions, thus simplifying the entire system of the present invention. Such a set up allows users to readily use the present invention, while avoiding data collision and data corruption inherent in more complicated data management systems. Conversely, in the preferred embodiment, it is the client that maintains state. In FIG. 1, client computer 101 initiates data record requests, and waits for a reply from stateless server 120. As such, client computers act independently, and may be added and removed from the system as needed, making the overall system faster, more robust, and easier to use.

While the router and the server are stateless, the database that holds the data records cannot be stateless, and so, by definition, must be able to “persist” the data in a persistence layer. The persistence layer, or persistence layers, contain an entire or portions of an entire updateable database, and are responsible for storing data, executing instructions and updating the database. One skilled in the art will appreciate that such a database can be located on a single persistence layer on a single stateless server, or distributed across multiple persistence layers connected to multiple stateless servers on a network, or any combination thereof. The persistence layer is not proprietary, and can be comprised of a commercially available database, such as MySQL® or OpenLDAP. MySQL® is a registered service mark owned by MySQL AB (http://www.mysql.com). OpenLDAP® is a registered service mark owned by the OpenLDAP Foundation (http://www.openldap.org).

The present invention is inherently flexible and scalable, and can be used to manage, maintain and organize any type of information. Data within the database is classified using a coherent system of domain names appropriate for the data being stored. Domain names may be borrowed from existing real world classification systems, such as animal and plant taxonomy, social security numbers, wine appellations, etc. Once the domain is in place, data records may easily be further organized into distinct groupings, or segments, by assigning each record a unique and distinct key, such as a time stamp or hashing member. The number of these groupings is the segmentation level, which also determines the number of separate servers and persistence layers required to practice the present invention. Layering a classification system on top of a data set and establishing a unique identifier for associated records is well understood in the art.

In one embodiment of the present invention, the router, server and the persistence layer exist as multiple entities divided into separate and distinct units by domain. Updates from a client are bound to a single segment of a domain such that each client may have its own separate and distinct router/server that in turn may have its own separate and distinct persistence layer. The benefit of this configuration is that it provides increased scalability and performance by distributing many of the tasks to separate routers, servers and/or separate persistent layers. By relying on the domain for segmentation, each client may act independently without fear of collision, or data corruption; clients are isolated from each other by observing distinct segmentation established by the domain. Furthermore, the initial definition of a domain may be done in a manner that provides extremely fine granularity, therefore increasing scalability and performance. Applying a pre-determined algorithm to the key creates segments. Such algorithms are well known in the art, and many algorithms, such as the Luhn Algorithm or other modulus type algorithm may be applied to verify and check the segmentation level. If an algorithm is not available, segmentation is not possible, but the system will still function. The system will default to a single router/server and persistence layer.

### The Data Record

Because the stateless router/server does not keep any record of prior transactions from the client computer to the persistence layer, data record queries must contain all of the information necessary to define and locate the desired record. Use of a common item-schema ensures standardization of record format. In one embodiment, the user composes queries according to the item-schema; however, in a preferred embodiment, query inputs are automatically formatted by the client computer to fit the item-schema.

Below is a record illustrating a self-describing record for a toothbrush, according to one embodiment of the present invention:

<item>

<key>uniqueId</key>
<data_payload>

<element>

<attribute1>toothbrush</attribute1>
<attribute2>10</attribute2>

</element>

</data_payload>

</item>

As shown, the record describes some significant elements that are necessary to maintain database organization. For example, each data record describes an item in the database that must be identified by its own unique key. In this example, the database may contain data on a store inventory, which may include items such as toothbrushes. Here, the key for the toothbrush is called “uniqueId,” and the data payload for the toothbrush includes two numbered attributes. Attribute1 could also be called “name,” and attribute2 could be called “size.”

One will appreciate that a data record is flexible and extensible, and can include as many or as few attributes that the user desires. Indeed, a more complex data record may include nested attributes, since the item-schema permits breaking up the elements of an item into finer grained attributes, as the following illustrates:

<item>

<key>

<part1>id-A</part1>
<part2>id-B</part2>

</key>
<data_payload>

<element>

<attribute1>

<part1>tooth</part1>
<part2>brush</part2>

</attribute1>
<attribute2>10</attribute2>

</element>

</data_payload>

</item>

The ability to customize the amount of data in a record allows the present invention to operate more efficiently with more options and less data overhead.

The self-describing nature of the data record, as shown above, creates added benefits. It provides the invention with the ability to manage the reading and writing of records without filtering or modifying them. This greatly simplifies the interchange of data and allows the server to write records from the client “as-is”, without regard to any other factors. This capability is provided by two features of the invention: segmentation and statelessness. By providing the system, catalog, or item in its entirety, the record is completely consistent and accurate for a single point in time, which results in efficient and accurate updating of the database.

### Building the System

The system elements described previously must be assembled such that the records have well-described relationships with each other, since there is no attempt to organize or synchronize records between themselves. Assembly simply requires the system elements depicted in FIG. 1 or FIG. 2 described above. The respective elements must be configured to adopt the item-schema and interact with the persistence layer. One skilled in the art will appreciate that the system elements are flexible and interchangeable, and can comprise equivalent structures that serve the same purpose.

Putting the system elements begins by setting up the persistence layer with the definitions or attributes for the data records it will be storing. Next the item-schema is defined to describe the item in its entirety. Following this, the router/server or routers/servers are set up and incorporated with the communication layer. These few steps are all that are needed to configure the router/server to use the item-schema, the persistence layer, and the communication layer. After setting up the system to practice the present invention, an associated client may be given the URL address of the server where the persistence layer is associated.

### Using the System

In a preferred embodiment, requesting and updating a record requires the following steps: in a first step, a user operating a client makes an HTTP request to the server. The client is responsible for generating the appropriate key or using an existing key, which are readily available and described in the art. As noted previously, the key represents a unique identifier for the item. For example, if the database is a store inventory, then the key could be a UPC code identifying a specific item. Alternatively, the key could identify certain attributes of a specific item, such as its manufacturer, product SKU, color, size or weight, all of which could be entered into an external system for creating a unique key for the item. In such an embodiment, the request could be made by scanning an item's UPC code or typing it into the client. Alternatively, a user could make the request by entering in an XML record according to the pre-determined schema, or the user could make the request in a browser application that accesses the server. In yet a further embodiment, a user inputs a plain language request, and the client will package the request in a form that conforms to the item-schema. One will appreciate that there are a number of well-known methods for requesting, calling up or accessing a data record, all of which may be understood by the present invention.

The nature of the request is determined by the item-schema. In one embodiment, the command to request a data record is “getItem,” and the command to update a data record is “updateItem.” The following script illustrates these two examples:

http://example.org/getItem?key=<key>A</key>
http://example.org/getItem?key=<key><part1>id-A</part1><part2>id-B</part2></key>
http://example.org/updateItem?rec=<key>uniqueId</key>

<data_payload>

<element>

<attribute1 >toothbrush</attribute1 >
<attribute2>10</attribute2>

</element>

</data_payload>

This exemplar script illustrates two uses of the “getItem” command and one use of the “updateItem” command. According to one embodiment, these scripts will be sent from the client to the server over HTTP. In the preferred embodiment, the URL path contains the key required to located the server and persist the record. One skilled in the art will appreciate that the use of different HTTP requests separates requests from updates. HTTP-GET is used for requests, HTTP-POST is used for creation, HTTP-PUT is used for updates, and HTTP-DELETE is used for destruction. For example, for a single key, the request may take the form of “http://example.org/item/1”. For a multipart key, it might read “http://example.org/topic/l /item/1”.

Another embodiment of the present invention permits the use of shorter commands such that a request for a data record may be framed simply as “GET”. In this embodiment, the item A from the above example could be obtained by entering “GET /item/A”. To create item A, one might input “POST /item/A”. To update item A, one might issue the command “PUT /item/A”. And to delete Item A, one might key in “DELETE /item/A”. One skilled in the art will appreciate that many different commands are possible, so long as the router has adopted the appropriate schema and is able to parse the relevant command.

Once the router/server receives the HTTP request, the request must be parsed to determine the type of request and to determine which record to access. Applying the above embodiment, parsing the request requires that the router/server determine if the request is an HTTP-GET, HTTP-POST, HTTP-PUT or HTTP-DELETE request. The present invention parses the URL to identify the nature of the command.

After identifying the last file name, the router sends the request to the correct server. The server retrieves the requested record as defined by the HTTP request. If the request is an HTTP-GET, the record is parsed from the URL by pulling out the value for the named parameter rec or key. If the request is an HTTP-POST, the record is also parsed from the body of the document. With both HTTP-GET and HTTP-POST request, the parsing is the same such that the value for the named parameter becomes the record.

Once the system has the record, it parses out the unique key identifier. For key requests, the record and the value of the parameter are the same. For record or “rec” requests, the key must be pulled from the record using standard XML parsing. XML parsing will compose the record into a format easily accessed by the system. One skilled in the art will appreciate that many different data structures will work in this embodiment.

After parsing out the key, the present invention will apply an algorithm to map the key to a domain. In one embodiment, the key might be the phone number for a store that is using the present invention to update inventory, in which case the algorithm concatenates the phone number to remove all non-numeric characters, leaving a number string used as the unique identifier of a record representing a store in a domain. Other algorithms that are well known in the art can be applied to create domain classification and to define further uniqueness.

Next, the present invention will use the segmentation level to group the requests. In one embodiment, the data record's key is divided by the segmentation level, and the resulting remainder identifies which persistence layer will service the request. The router uses this information to send the request to the appropriate server, which in turn sends the request to the appropriate persistence layer. Thus, the present invention has uncovered the type of request and the proper persistence layer destination. With these in hand, the present invention will transform the request into a format required by the persistence layer. In one embodiment, the persistence layer is a database such that a SQL statement must be created. In another embodiment, the persistence layer is a flat file store such that a fully qualified path will be used to directly write or read the entire file. One skilled in the relevant art will appreciate that other types of persistence layers are also possible.

Once the router/server sends the request and connects to the right persistence layer, the correctly formatted commands are passed directly to the persistence layer. The server receives the status of the command, which it passes back to the client, via the router, by sending an HTTP status code indicating the success or failure of the operation. The status code is then processed by the client. As specified by the HTTP protocol, success is indicated by a return code between 200-299, and failure is indicated by a return code between 400-599. In an alternative embodiment, the client will only wait for a fixed period of time. If this fixed period of time expires, the client will consider the request to have failed. After transmitting the return code, the server closes the HTTP connection. One will appreciate that it is possible to have a more detailed error reporting system.

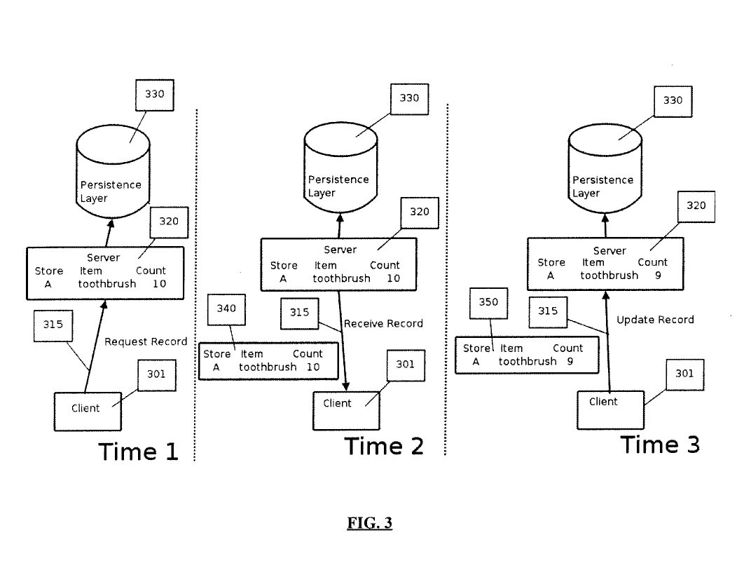

FIG. 3 illustrates symbolically the interaction between a client 301, a stateless router/server 320, and a single persistence layer 330, connected via a network 315. Using the above XML script examples, at Time 1, the client 301 requests a record on the router/server 320. The client makes this request using its domain key, store=A. At Time 2, the present invention extracts the record 340 from the persistence layer 330 and transmits it over the network 315 to the client 301. Meanwhile, the “count,” or inventory for the requested item, toothbrush, is reduced from 10 to 9. At Time 3, the client 301 sends the updated record 350 back to the router/server 320. Note that the request and the update may be achieved in two separate steps, a getItem step and an updateItem step, or both the request and the update may be achieved using a single updateItem command. The present invention permits such flexibility so long as the schema establishes that such operations are understood.

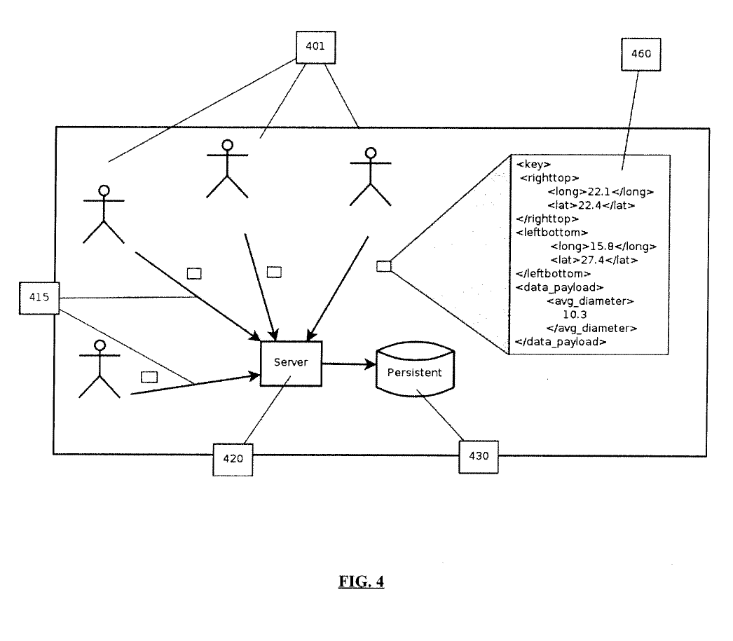

In another embodiment, the present invention is segmentable across systems connected to more than one persistence layer. The present invention is applicable to multiple industries to handle multiple types of data. For example, the present invention could be used in the context of land resource management. FIG. 4 illustrates how multiple clients 401 may access a single router/server 420 on a network 415 that is associated with only one persistence layer 430. Despite the number of clients connected to the network, each client 401 can transmit updates 460 to the router/server 420, which will automatically parse the requests and updates and make changes to the persistence layer 430 database accordingly. If a client 401 updates the same record as another, the present invention can choose to keep the newest record.

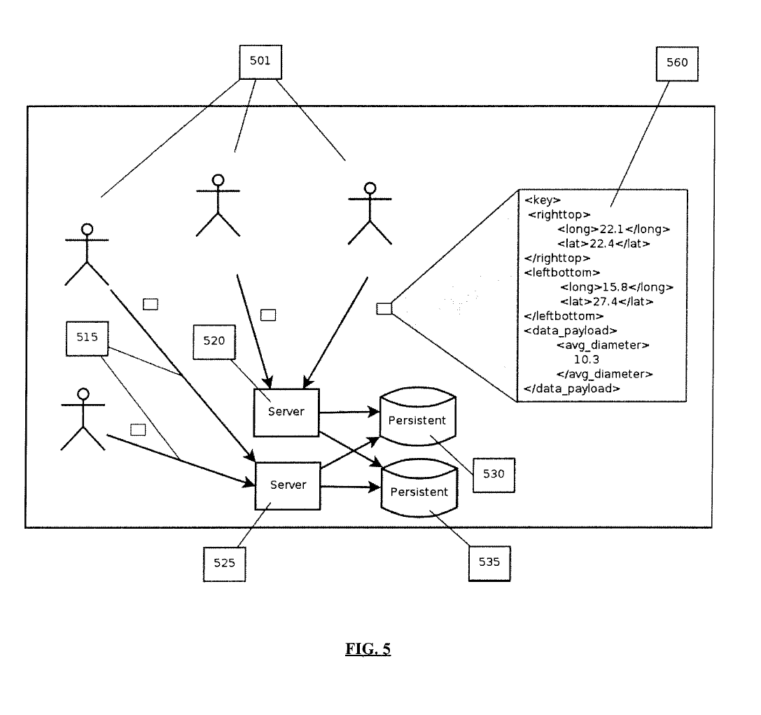

In yet another embodiment, the present invention may work with multiple servers with multiple persistence layers. Using the same example illustrated in FIG. 4, FIG. 5 shows symbolically how a plurality of clients 501 can access the same database distributed on multiple servers 520 and 525 and multiple persistence layers 530 and 535, over a network 515. The servers 520 and 525 perform the segmentation necessary to route the commands 560 to the appropriate persistence layer 530 and 535.

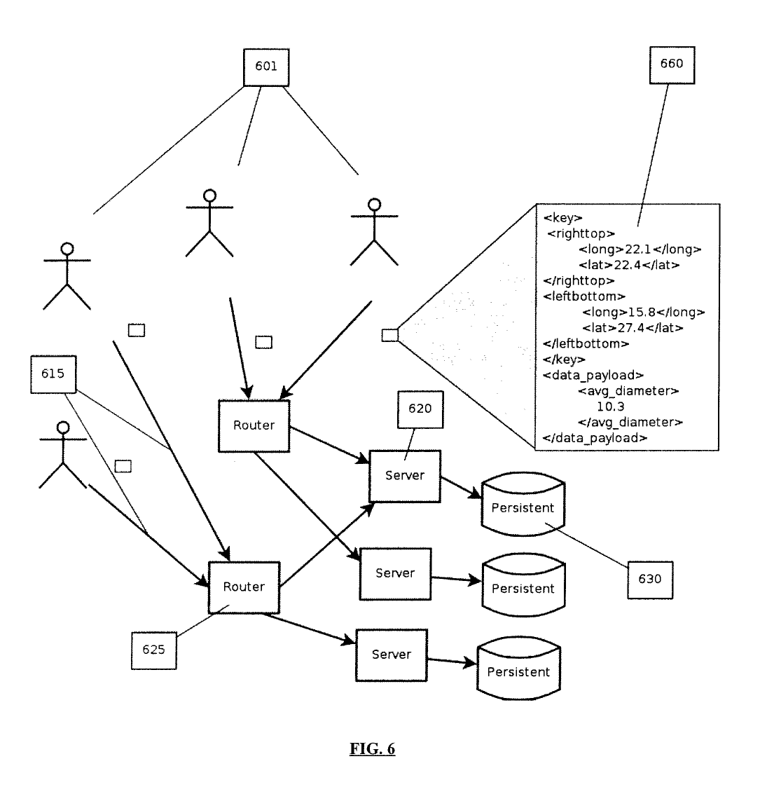

In yet another embodiment, the present invention may work with multiple routers, servers, and persistence layers. FIG. 6 shows symbolically how a plurality of clients 601 can access the same persistence layers 630 distributed on multiple servers 620, through the use of a plurality of routers 625. In this configuration, the servers 625 perform the segmentation necessary to route the commands 660 to the appropriate persistence layer 630 over network 615.

Although embodiments of the present invention have been described with reference to a network implementation comprising the internet and internet-related web browsing and web serving technologies, it should be noted that alternative embodiments of the present invention can be implemented on many other types of networks and network protocols, such as proprietary protocols for local area networks, wide area networks, and any combination thereof.

In the foregoing, the system has been described for requesting, accessing, updating and returning data over a network. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than restrictive sense.

What is claimed is:

1. In a network with a database system stored in a persistence layer associated with one or more stateless servers, a process comprising:
providing a database system stored in a persistence layer associated with a stateless server and a stateless router;
receiving a query for a previously-stored data record by the stateless server;
parsing the query by the stateless router to identify a command and a key;
routing, by the stateless server, the parsed query to at least one persistence layer where data records are stored; and
locating the previously-stored data record that is responsive to the query.

2. The process of claim 1, further comprising, as an initial step, adopting a schema that describes an acceptable format for the query and data record.

3. The process of claim 1, further comprising transmitting a status code to the client.

4. The process of claim 1, wherein the parsing step further comprises applying an algorithm to the data record to create a unique identifier.

5. The process of claim 1, wherein the parsing step is performed by the stateless server.

6. The process of claim 2, prior to the routing step, the process further comprising grouping at least one data record by a segmentation level number.

7. The process of claim 1, further comprising transmitting the data record to the client.

8. The process of claim 3, wherein the transmitting step further comprises transmitting a status code selected from a group consisting of success and failure.

9. The process of claim 8, wherein the failure status code is transmitted after completion of a pre-determined timeout period that begins when the query is first sent from the client.

10. A system comprising:
a stateless server computer capable of receiving instructions from a client computer without keeping a memory record of the received instructions;
a stateless router computer associated with the stateless server computer, the stateless router computer capable of parsing instructions received from a client computer without keeping a memory record of the received instructions;
a persistence layer associated with the stateless server, the persistence layer storing at least one data record; and
a schema associated with the the stateless server computer, the schema describing an acceptable format for instructions to the stateless server computer.

11. The system of claim 10, wherein the stateless server is a software application that resides on the stateless server computer.

12. The system of claim 10, wherein the persistence layer resides on the stateless server computer.

13. The system of claim 10, wherein the client computer and the stateless server computer are a single computer.

14. The system of claim 10, wherein the stateless router computer and the stateless server computer are a single computer.
